(19) United States
(12) Patent Application Publication
(10) Pub. No.: US 2006/0078321 A1
(43) Pub. Date: Apr. 13, 2006

(54) Picture display device

(75) Inventors: Hiroyuki Osawa, Hanno-shi (JP); Tomoyoshi Furusawa, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/244,061

(22) Filed: Oct. 6, 2005

(30) Foreign Application Priority Data
Oct. 8, 2004 (JP) 2004-296582

(51) Int. Cl. G03B 17/02

(52) U.S. Cl. 396/6

(57) ABSTRACT

A picture display device comprises a device main body, a covering body, a link mechanism, an operating protrusion, an opening and closing detecting switch and an control unit. The device main body restores and outputs a picture signal. The covering body has a picture display unit for displaying the picture signal from the device main body. The link mechanism couples the device main body and the covering body in a multi-axis manner and can be turned by orienting the covering body with respect to the device main body. The operating protrusion is formed on a face of the covering body. The opening and closing detecting switch can be pressed by the operating protrusion when the covering body is closed, causing the picture display unit to face the device main body. The control unit turns off the picture display unit when the switch is been operated.

### CROSS-REFERENCE TO RELATED APPLICATIONS

This application is based upon and claims the benefit of priority from prior Japanese Patent Application No. 2004-296582, filed Oct. 8, 2004, the entire contents of which are incorporated herein by reference.

### BACKGROUND OF THE INVENTION

1. Field of the Invention

The present invention relates to a picture display device configured so that a covering body comprising a picture display unit is openably supported with respect to a device main body.

2. Description of the Related Art

As is well known, in the recent years, a technique of recording information with high density has been accelerated. There has been practically used an optical disk called a digital versatile disk (DVD) having a recording capacity of 4.7 giga bytes (GB) on a single sided layer.

An optical disk reproducing device which reproduces data from an optical disk of this type is composed of: a device main body comprising a housing unit which houses an optical disk, a disk motor which rotates the housed optical disk, an optical head which reads data from the rotated optical disk, and a circuit unit which restores the data read by the optical head as a picture signal; and a covering body comprising a picture display unit which displays the restored picture signal, the covering body being openably supported with respect to the device main body.

In Jpn. Pat. Appln. KOKAI Publication No. 2002-288974, there is disclosed an optical disk reproducing device having such a configuration which comprises an opening and closing detecting mechanism which detects a turning position of a covering body with respect to a device main body, wherein, when the device main body and covering body are set to be equal to or smaller than a predetermined angle, a display unit of the covering body is automatically powered off. However, this configuration disclosed in Jpn. Pat. Appln. KOKAI Publication No. 2002-288974 has a problem that a structure of the opening and closing detecting mechanism is complicated, and is not suitable for downsizing.

### BRIEF SUMMARY OF THE INVENTION

According to one aspect of the present invention, there is provided a picture display device comprising: a device main body configured to restore and output a picture signal; a covering body configured to have a picture display unit which displays a picture signal outputted from the device main body; a link mechanism configured to couple the device main body and the covering body with each other in a multi-axis manner and to be turnable by orienting the covering body in a multi-directional manner with respect to the device main body; an operating protrusion formed at a predetermined position of a face of the covering body on which the picture display unit is exposed; an opening and closing detecting switch provided at the device main body, the switch being configured to be pressed and operated by the operating protrusion when the covering body has been closed so as to cause the picture display unit to face the device main body; and a control unit configured to power off the picture display unit when the opening and closing detecting switch has been operated to be pressed.

### BRIEF DESCRIPTION OF THE SEVERAL VIEWS OF THE DRAWING

FIG. 1 is a perspective view showing one embodiment of the present invention, the perspective view being provided to explain an appearance of an optical disk reproducing device;

FIG. 2 is a perspective view for explaining one closed state of the optical disk reproducing device in the embodiment;

FIG. 3 is a perspective view for explaining the other closed state of the optical disk reproducing device in the embodiment;

FIG. 4 is a side view for explaining a positional relationship between an operating protrusion and an opening and closing detecting switch of the optical disk reproducing device in the embodiment;

FIG. 5 is a side view for explaining a state in which the opening and closing detecting switch has been operated by means of the operating protrusion of the optical disk reproducing device in the embodiment;

FIG. 6 is a side view for explaining a state in which the opening and closing detecting switch is made inactive by the operating protrusion of the optical disk reproducing device in the embodiment;

FIG. 7 is a block diagram for explaining a signal processing system of the optical disk reproducing device in the embodiment; and

FIG. 8 is a side view for explaining a modified example of the optical disk reproducing device in the embodiment; and

FIG. 9A and FIG. 9B are views for explaining a structure of an opening and closing detecting switch used in the modified example of the optical disk reproducing device in the embodiment.

### DETAILED DESCRIPTION OF THE INVENTION

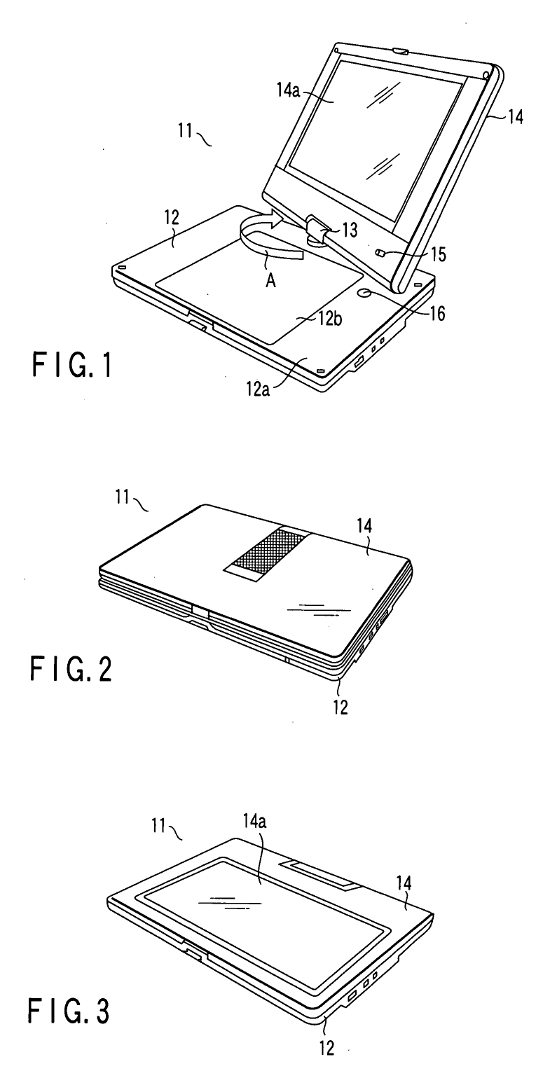

Hereinafter, one embodiment of the present invention will be described in detail with reference to the accompanying drawings. FIG. 1 shows an appearance of an optical disk reproducing device 11 explained in the embodiment.

The optical disk reproducing device 11 is composed of: a device main body 12 formed in a substantially thin box shape; and a substantially planar shaped covering body 14 turnably linked with a substantial center of one end of the device main body 12 via a hinge mechanism 13.

Among them, a housing unit 12b which houses an optical disk in one main plane 12a is provided in the device main body 12. The device main body has incorporated therein: a disk motor which rotates the optical disk housed in the housing unit 12b; an optical head which reads data from the rotated optical disk; a circuit unit which restores the data read by the optical head as a picture signal; and the like.

In addition, on the above covering body 14, a picture display unit 14a comprising, for example, a liquid crystal display panel or the like is exposed for displaying the picture signal restored by the circuit unit of the above device main body 12.

Further, the hinge mechanism 13 links a substantial center of one end of the device main body 12 and a substantial center of one end of the covering body 14 with each other, and supports the covering body 14 with respect to the device main body 12 so as to turn on the periphery of substantially orthogonal two axes, respectively.

That is, the covering body 14 is turnable with respect to the main plane 12a of the device main body 12 in a direction in which a face of the picture display unit 14a is opened and closed, in a so-called driving direction. The covering body 14 also can invert an orientation of the face of the picture display unit 14a by 180 degrees by turning it in a direction indicated by the arrow A, a so-called twisting direction with respect to the device main body 12 in a state in which the covering body 14 has been erected to be substantially vertical to the device main body 12.

In this manner, the optical disk reproducing device 11 closes the covering body 14 so as to cause the picture display unit 14a to face the main plane 12a of the device main body 12, whereby the picture display unit 14a can be set in a closed state in which this display unit is not exposed, as shown in FIG. 2.

In addition, the optical disk reproducing device 11 closes the covering body 14 so as to cause a face situated at the opposite side to the side at which the picture display unit 14a of the covering body 14 is installed to face the main plane 12a of the device main body 12, whereby the picture display unit 14a can be set in a closed state in which its surface has been exposed, as shown in FIG. 3.

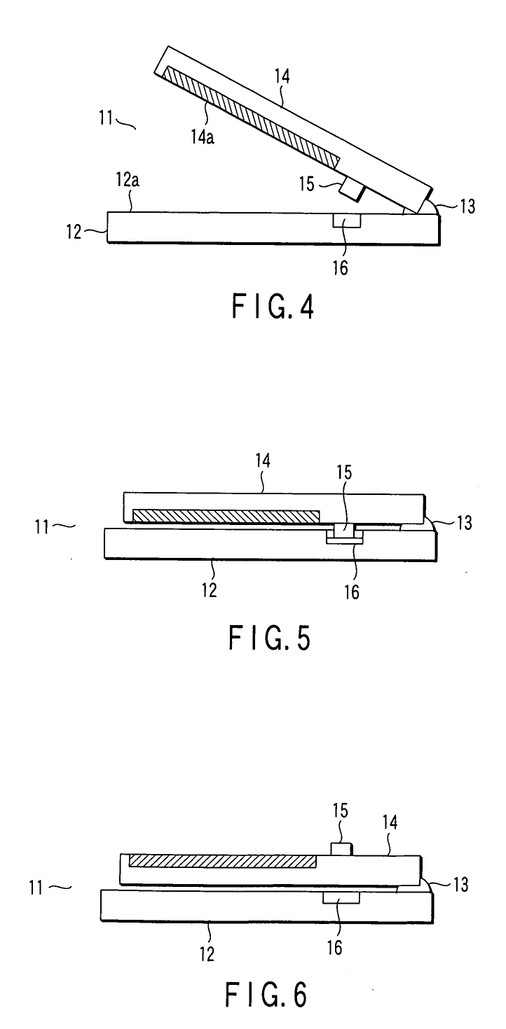

Here, as shown in FIGS. 1 and 4, on the covering body 14, an operating protrusion 15 is installed at a predetermined position of a face situated at the side at which its picture display unit 14a is exposed. In addition, on the main plane 12a of the device main body 12, an opening and closing detecting switch 16 is installed at a position which corresponds to the operating protrusion 15 in a state in which the covering body 14 is closed as shown in FIG. 2. The opening and closing detecting switch 16 is installed so as to have the same height as the main plane 12a of the device main body 12.

Thus, as shown in FIG. 2 previously, in the case where the covering body 14 has been closed such that the picture display unit 14a is not exposed, the opening and closing detecting switch 16 is operated to be pressed by the operating protrusion 15, as shown in FIG. 5.

Then, in a state in which the opening and closing detecting switch 16 has been operated to be pressed, power supply to the picture display unit 14a is interrupted, the picture display unit 14a is powered off, and power supply to the above-described disk motor, optical head, circuit unit and the like is also stopped.

In contrast, as shown in FIG. 3 previously, in the case where the covering body 14 has been closed such that the picture display unit 14a is exposed, the opening and closing detecting switch 16 is not operated to be pressed by the operating protrusion 15, as shown in FIG. 6. Thus, power supply to the picture display unit 14a, disk motor, optical head, circuit unit and the like is not stopped, making it possible to display a picture.

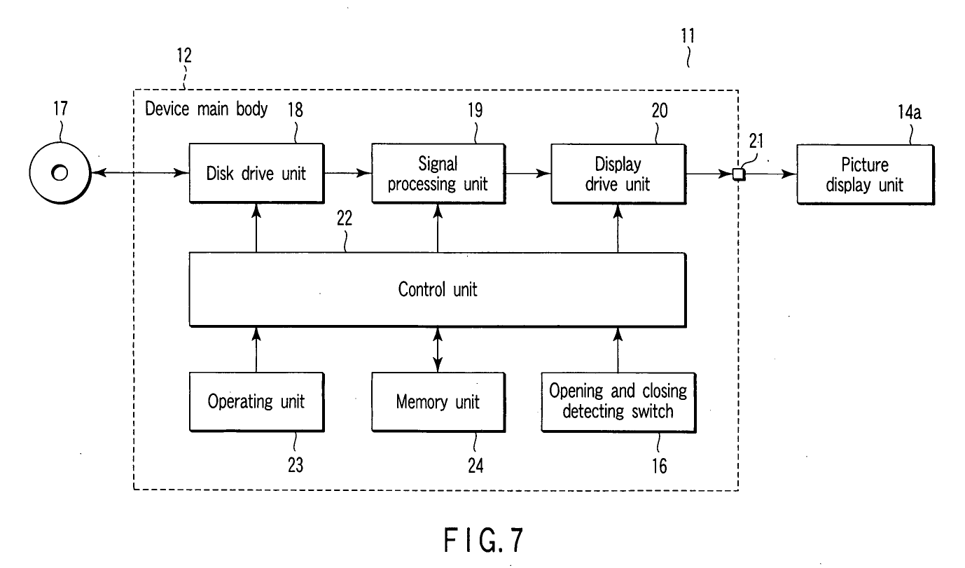

FIG. 7 shows a signal processing system of the above-described optical disk reproducing device 11. That is, an optical disk 17 such as a DVD which is a recording medium is mounted on a disk drive unit 18. The disk drive unit 18 has a disk motor or an optical head, and has a function of rotationally driving the mounted optical disk 18 to read the recorded data.

The data read by the disk drive unit 18 is restored as a picture signal by being supplied to a signal processing unit 19 and demodulated there. Then, the picture signal restored by the signal processing unit 19 is delivered via a display drive unit 20 which drives the picture display unit 14a so as to display the picture signal as a picture. Then, the picture signal is supplied to the picture display unit 14a of the covering body 14 via a connection terminal 21, and is displayed a picture.

Here, in this optical disk reproducing device 11, all of the operations including the above-described reproducing operation is integrally controlled by a control unit 22. The control unit 22 incorporates a central processing unit (CPU) and the like, and receives operational information from an operating unit 23 to control each unit such that its operational contents are reflected.

In this case, the control unit 22 utilizes a memory unit 24. The memory unit 24 mainly includes a read only memory (ROM) having stored therein a control program executed by a CPU, a random access memory (RAM) which provides a work area to the CPU, and a nonvolatile memory having stored therein a variety of setting information and control information.

The opening and closing detecting switch 16 is also connected to the control unit 22, so that its operational information is inputted to the control unit 22. When the opening and closing detecting switch 16 is an inactive state, namely, in an OFF state, the control unit 22 controls power supply to the disk drive unit 18 and display drive unit 20.

In this manner, data is read from the optical disk 17 by means of the disk drive unit 18, and power is supplied to the picture display unit 14a via the display drive unit 20, making it possible to display a picture.

On the other hand, when the opening and closing detecting switch 16 is in an operating state, namely, in an ON state, the control unit 22 makes control so as to interrupt power supply to the disk drive unit 18 and the display drive unit 20.

In this manner, data is not read from the optical disk 17 by means of the disk drive unit 18, and power is not supplied to the picture display unit 14a via the display drive unit 20. Then, the picture display unit 14a is powered off.

According to the above-described embodiment, the operating protrusion 15 is installed at a predetermined position on the face on which the picture display unit 14a of the covering body 14 is installed. Then, the operating and closing detecting switch 16 operated to be pressed by the operating protrusion 15 is provided at the device main body 12 in a state in which the covering body 14 is closed such that the picture display unit 14a faces the main plane 12a.

Thus, in the case where the covering body 14 has been closed such that the picture display unit 14a is not exposed, the opening and closing detecting switch 16 is operated to be pressed by the operating protrusion 15, and the picture display unit 14a is powered off. In the case where the covering body 14 has been closed such that the picture display unit 14a is exposed, the opening and closing detecting switch 16 is not operated to be pressed by the operating protrusion 15, so that a picture is displayed at the picture display unit 14a.

That is, the device main body 12 and the covering body 14 comprising the picture display unit 14a are coupled with each other by the hinge mechanism 13 in a bi-axial manner, and the covering body 14 is turnable to be oriented in a multi-directional manner with respect to the device main body 12. In this configuration, it becomes possible to power off a picture display only when the covering body 14 is closed such that the face of the picture display unit 14a is opposed to the main plane 12a of the device main body 12 with a very simple configuration.

In this way, when the opening and closing detecting switch 16 is operated, the picture display unit 14a is powered off, so that it is possible to reduce power consumption and to suppress heating when the picture display unit 14a is powered on. In addition, power supply to the disk drive unit 18 is stopped, thus making it more effective for the purpose of reduction of power consumption.

Here, the above embodiment has described that operational information on the opening and closing detecting switch 16 is inputted to the control unit 22, and the control unit 22 controls the disk drive unit 18 and the display drive unit 20, but not limited thereto. It is also possible to make control by directly connecting the opening and closing detecting switch 16, the disk drive unit 18, and the display drive unit 20 via a harness, for example.

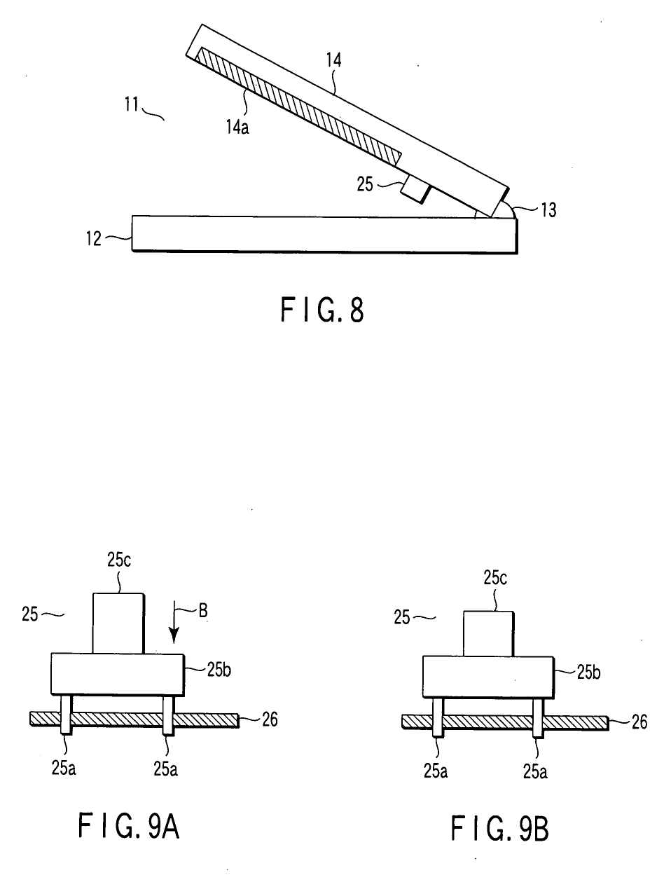

FIG. 8 shows a modified example of the above embodiment. That is, referring to FIG. 8 in which like constituent elements in FIG. 4 are designated by like reference numerals, an opening and closing detecting switch 25 is installed instead of the operating protrusion 15 at a predetermined position of the face on which the picture display unit 14a of the covering body 14 is installed.

The opening and closing detecting switch 25, as shown in FIG. 9A, comprises an operating unit 25c which protrudes from a switch main body 25b connected to a circuit board 26 via a lead wire 25a. The operating unit 25c is operated to be pressed in a direction indicated by the arrow B, whereby the opening and closing detecting switch 25 is shifted to an operating position shown in FIG. 9B from an inactive position shown in FIG. 9A. In the case of this example, the operating unit 25c of the opening and closing detecting switch 25 protrudes by a predetermined distance from the face on which the picture display unit 14a of the covering body 14 is installed.

According to the configuration as shown in FIG. 8, in the case where the covering body 14 has been closed such that the picture display unit 14a is not exposed, the operating unit 25c of the opening and closing detecting switch 25 is operated to be pressed by the main plane 12a of the device main body 12, and is set to an ON state. Thus, the picture display unit 14a is powered off.

In the case where the covering body 14 has been closed such that the picture display unit 14a is exposed, on the other hand, the operating unit 25c of the opening and closing detecting switch 25 is not operated to be pressed, and is set to an OFF state. Thus, a picture is displayed at the picture display unit 14a.

The present invention is not limited to the above-described embodiment, and can be embodied by variously modifying constituent elements without departing from the spirit of the invention at a stage of carrying out the invention. In addition, a variety of inventions can be formed by properly combining a plurality of constituent elements disclosed in the embodiment. For example, some of all the constituent elements shown in the embodiment may be eliminated. Further, constituent elements according to different embodiments may be properly combined with each other.

What is claimed is:

1. A picture display device comprising:
a device main body configured to restore and output a picture signal;
a covering body configured to have a picture display unit which displays a picture signal outputted from the device main body;
a link mechanism configured to couple the device main body and the covering body with each other in a multi-axis manner and to be turnable by orienting the covering body in a multi-directional manner with respect to the device main body;
an operating protrusion formed at a predetermined position of a face of the covering body on which the picture display unit is exposed;
an opening and closing detecting switch provided at the device main body, the switch being configured to be pressed and operated by the operating protrusion when the covering body has been closed so as to cause the picture display unit to face the device main body; and
a control unit configured to power off the picture display unit when the opening and closing detecting switch has been operated to be pressed.

2. A picture display device according to claim 1, wherein the link mechanism is configured to enable closing the covering body so as to cause a face opposite to the face of the covering body on which the picture display unit is exposed to face the device main body.

3. A picture display device according to claim 1, wherein the control unit is configured to, when the opening and closing detecting switch has been operated to be pressed, interrupt power supply to the picture display unit and power off the picture display unit.

4. A picture display device according to claim 1, wherein the device main body comprises:
a drive unit configured to read recorded data by driving a recording medium;
a signal processing unit configured to restore a picture signal from the data read by the drive unit; and
a driving unit configured to drive the picture display unit so as to display the picture signal restored by the signal processing unit, and
the control unit is configured to, when the opening and closing detecting switch has been operated to be pressed, interrupt power supply to the drive unit and driving unit and power off the picture display unit.

5. A picture display device comprising:
a device main body configured to restore and output a picture signal;
a covering body configured to have a picture display unit which displays a picture signal outputted from the device main body;
a link mechanism configured to couple the device main body and the covering body with each other in a multi-axis manner and to be turnable by orienting the covering body in a multi-directional manner with respect to the device main body;
an opening and closing detecting switch provided at a predetermined position of a face of the covering body on which the picture display unit is exposed, the switch being configured to be pressed and operated by means of the device main body when the covering body has been closed so as to cause the picture display unit to face the device main body; and
a control unit configured to power off the picture display unit when the opening and closing detecting switch has been operated to be pressed.

6. A picture display device according to claim 5, wherein the link mechanism is configured to enable closing the covering body so as to cause a face opposite to the face of the covering body on which the picture display unit is exposed to face the device main body.

7. A picture display device according to claim 5, wherein the control unit is configured to, when the opening and closing detecting switch has been operated to be pressed, interrupt power supply to the picture display unit and power off the picture display unit.

8. A picture display device according to claim 5, wherein the device main body comprises:
a drive unit configured to read recorded data by driving a recording medium;
a signal processing unit configured to restore a picture signal from the data read by the drive unit; and
a driving unit configured to drive the picture display unit so as to display the picture signal restored by the signal processing unit, and
the control unit is configured to, when the opening and closing detecting switch has been operated to be pressed, interrupt power supply to the drive unit and driving unit and power off the picture display unit.

9. A picture display device comprising:
a device main body formed in a substantially thin box shape, the device main body being configured to reproduce and output a picture signal from a recording medium;
a covering body formed in a substantially planer shape, the covering body being configured so that a picture display unit to display a picture signal outputted from the device main body is exposed on one plane thereof;
a link mechanism which links a substantial center of one end of the device main body and a substantial center of one end of the covering body and supports the covering body to be turnable in a driving direction and a twisting direction with respect to the device main body, the link mechanism being configured to enable closing the covering body so as to cause a face opposite to the face of the covering body on which the picture display unit is exposed to face the device main body;
an opening and closing detecting switch configured to be pressed and operated when the covering body has been closed so as to cause the picture display unit to face the device main body; and
a control unit configured to power off the picture display unit when the opening and closing detecting switch has been operated to be pressed.

10. A picture display device according to claim 9, wherein the opening and closing detecting switch is provided at the device main body, and is configured to be pressed and operated by an operating protrusion formed at a predetermined position of the face of the covering body on which the picture display unit is exposed when the covering body has been closed so as to cause the picture display unit to face the device main body.

11. A picture display device according to claim 9, wherein the opening and closing detecting switch is provided at a predetermined position of the face of the covering body on which the picture display unit is exposed, and is configured to be pressed and operated by the device main body when the covering body has been closed so as to cause the picture display unit to face the device main body.
